(19) United States
(12) Patent Application Publication
(10) Pub. No.: US 2004/0197242 A1
(43) Pub. Date: Oct. 7, 2004

(54) Mid-bed catalyst sensor with silica insulation

(76) Inventors: Ian Holden, Sheriffemales (US); Jim Bowman, Indianapolis, IN (US); Freddie Baldwin, Columbus, IN (US); Dan Poling, Columbus, IN (US)

Correspondence Address: CARLSON, GASKEY & OLDS, P.C., 400 WEST MAPLE ROAD, SUITE 350, BIRMINGHAM, MI, 48009, US

(21) Appl. No.: 10/407,988

(22) Filed: Apr. 4, 2003

(51) Int. Cl. B01D 53/34

(52) U.S. Cl. 422/179; 422/177; 422/180; 29/890

(57) ABSTRACT

The present invention involves reduction of exhaust emissions through the use of a catalytic converter which has at least one sensor disposed between two or more beds of solid catalysts, or mid-bed, and which does not include an external heat shield.

### BACKGROUND OF THE INVENTION

1. Field of the Invention

The present invention relates to catalysts, or catalytic converters, utilized with internal combustion engine systems, specifically catalytic converter with sensor systems to monitor the converter operation.

2. Description of the Related Art

Internal combustion engines exhaust undesirable gases which are the subject of governmental regulations. Consequently, manufacturers of internal combustion engines, whether gasoline or diesel powered, have sought to reduce the emissions from such engines. Emissions gases from internal combustion engines include oxides of nitrogen, NOₓ.

One approach to reducing NOₓ emissions from internal combustion engines has been a catalytic reduction of NOₓ to elemental nitrogen. Following nitrogen reduction exhaust may be passed over an oxidation catalyst to oxidize the unburned hydrocarbons and carbon monoxide.

A problem with known catalytic converters has been the need for locating sensors downstream of the converters to monitor the catalytic converter operations. Catalytic converters often are used in conjunction with an external heat shield to shield near by components from excess heat which may result in damage or fire, such as interior floor material of an automobile or the ignition of dry vegitation beneath the vehicle. When used, an external heat shield consumes some of the limited package space within the vehicle and incrementally adds weight as well as the cost of manufacturing.

### SUMMARY OF THE INVENTION

The present invention involves reduction of emissions from an internal combustion engine through the use of a catalytic converter which has at least one sensor disposed between two or more beds of solid catalysts. The present invention also provides a means to forego an external heat shield.

Most generally, the present invention provides a catalytic converter including a housing, a plurality of catalyst supports disposed in the housing with a catalyst being applied to at least one catalyst support. Preferably, the catalytic converter comprises two or more catalyst supports. The catalyst supports define a cavity between at least two of the catalyst supports. A wire mesh separator extends between the two substrates across the cavity. The wire mesh at least partially wraps the circumference of the catalyst support within the housing. Where the wire mesh wraps the circumference of the catalyst support within the housing, the wire mesh is in contact with the housing and the catalyst support i.e., the wire mesh is between the housing and the catalyst support. There is at least one aperture in the mesh separator co-located with an aperture in the housing adapted to accommodate a sensor within the cavity.

The present invention further provides a catalytic converter comprising a housing, a plurality of supported catalysts disposed in the housing, and defining at least one cavity between catalysts, with the cavity being insulated and adapted to receive a sensor.

The present invention further comprises a catalytic converter for an exhaust system including a housing disposed in an exhaust stream, a plurality of supports for catalyst disposed within the housing wherein the catalyst supports and the housing define at least one cavity, a wire mesh support extending between the substrates and across the cavity, with the wire mesh support and housing having one or more co-located apertures adapted to receive a sensor inserted into the cavity.

The present invention also provides a method of making a catalytic converter capable of sensing conditions within the catalytic converter, the method includes providing a housing and placing a plurality of supported catalysts within the housing such that at least one cavity is defined between the supported catalysts, placing a separator advantageously of wire mesh within the housing such that the separator over wraps at least a portion of the supported catalysts, said separator being disposed between the supported catalyst and the housing and sufficiently compressed so as to fixedly position the catalyst support within the housing, and inserting a sensor into the cavity through the housing and the separator.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of a exhaust emissions system;

FIG. 2A is partial cutaway view of a catalytic converter in accordance with the present invention and a part of the exhaust emissions system of FIG. 1;

FIG. 2B is a sectional view of the front half of the catalytic converter of FIG. 2A, the catalytic converter being viewed from the inside;

FIG. 3 is an enlarged fragmentary view of a wire mesh support used in the catalytic converter of FIG. 2A and FIG. 2B; and

FIG. 4 is a sectional view of the mesh structure of FIG. 3 with a sensor inserted therethrough.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, in several forms, and such exemplifications are not to be construed as limiting the scope of the invention in any manner.

### DESCRIPTION OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings.

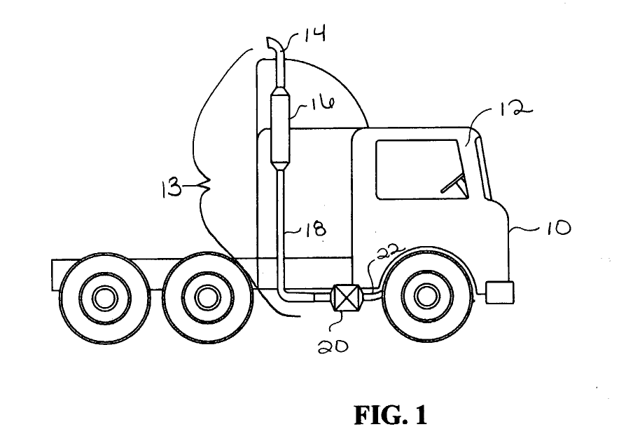

Referring to FIG. 1, motor vehicle 10 includes an engine (not shown) within, or proximate to, cab 12 and exhaust system 13 generally connected to the engine and facilitating removal of exhaust gases created during operation of the engine.

Exhaust system 13 includes exhaust 14, or tailpipe, extending from the body of vehicle 10 and muffler 16 connected to exhaust 14. In exhaust flow communication with muffler 16 is exhaust system pipe 18 which is also in exhaust flow communication with catalytic converter 20. Exhaust gases created by the engine pass through exhaust system 13 via additional exhaust system pipe 22 then through catalytic converter 20, exhaust system pipe 18, and muffler 16, and then is finally vented via exhaust 14. Although catalytic converter 20 is shown as being located beneath cab 12 of vehicle 10, catalytic converter 20 alternatively may be located at other positions relative to the engine and exhaust 14.

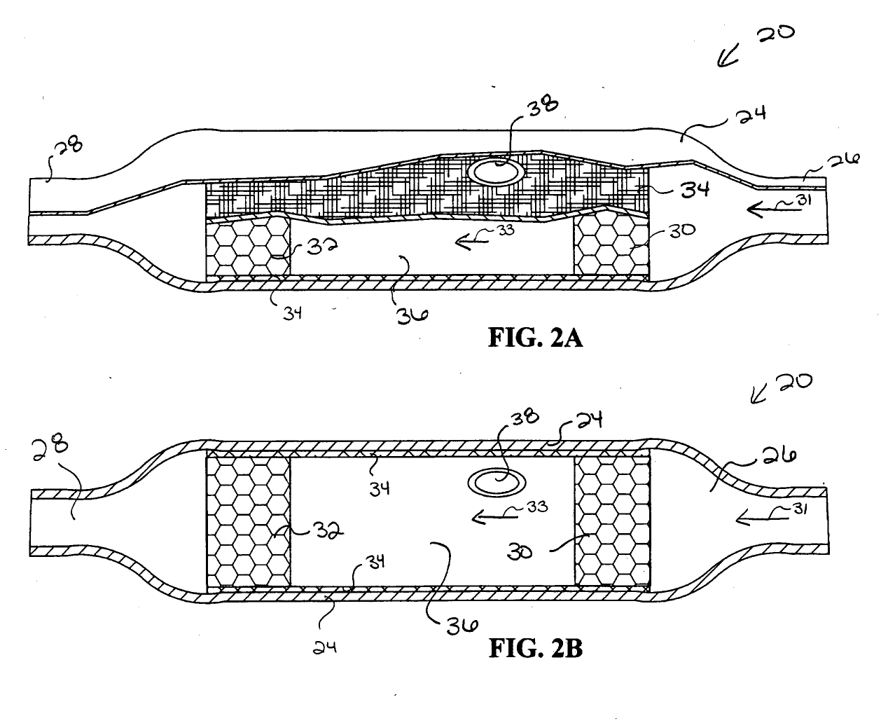

Catalytic converter 20 is shown in a partial cut-away view and a rear sectional view in FIG. 2A and FIG. 2B. Catalytic converter 20 includes outer housing 24 which includes tapered ends 26 and 28 that are connected to exhaust system pipes 18 and 22, respectively. Housing 24 comprises a metal that is durable and able to withstand dings and dents incident when used in motor vehicle applications. Disposed within housing 24 are two substrates 30 and 32 that support a catalyst for the necessary chemical reactions with the exhaust gases passing through catalytic converter 20. Customarily, substrates for supported catalysts comprise a ceramic. Substrate 30 may be coated with a reduction reaction agent. Substrate 32 may be coated with an oxidation reaction agent. The relative positions of the catalysts with respect to the exhaust flow, as indicated by arrows 31 and 33, is not critical to the instant invention. However, in the instant illustration, exhaust gases leaving the engine will pass through substrate 30 first and undergo the reduction reaction and then pass through substrate 32 for the oxidation reaction; such movement is indicated by arrows 31 and 33. Both catalyst supports 30 and 32 are illustrated as having a generally honeycomb structure, as indicated in FIG. 2A and FIG. 2B, but may have alternative structures enabling exhaust gas to contact the catalyst supported on the structure.

Surrounding, and supporting, substrates 30 and 32 is wire mesh support 34. As shown in FIG. 2A and FIG. 2B, wire mesh support 34 surrounds the outer circumference of substrates 30 and 32 such that substrates 30 and 32 are maintained in position and supported within housing 24. Wire mesh support 34 is illustrated as an open-ended cylinder with substrates and 32 being disposed at either end of the cylinder. Substrates 30 and 32 are located within wire mesh support 34 such that open space, or cavity, 36 is defined by substrates 30 and 32 and wire mesh support 34. Generally, cavity 36 serves as a passage for exhaust gas during operation of catalytic converter 20. The wire-mesh support provides a resilient means to grip and maintain the position of the inelastic catalyst support within the catalytic converter housing. Compression on the wire-mesh support, and consequently on the catalyst support is provided by wrapping the support and wire mesh with the metal support housing then fastening the metal in place as by crimping, bolting, or welding. The resiliency of wire-mesh support also accommodates the dimensional changes occasioned by thermal cycling of the components of the catalytic converter.

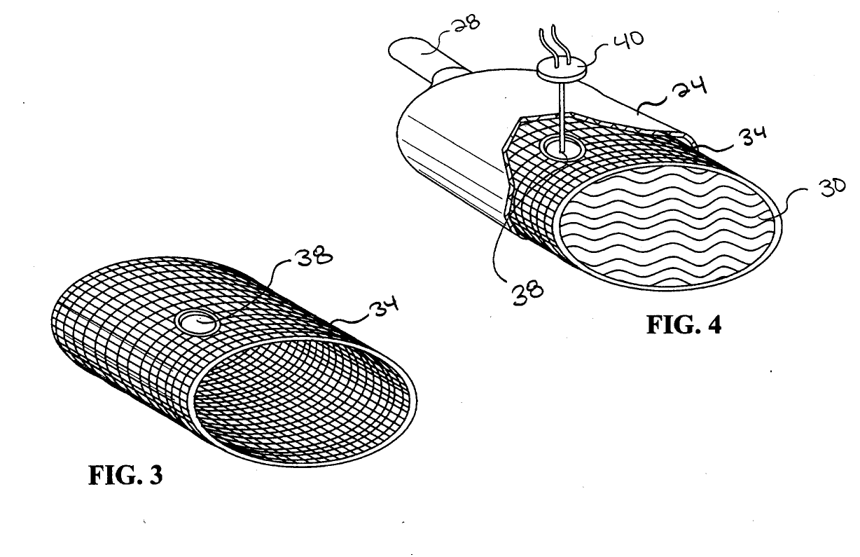

Wire mesh support 34 defines opening 38, as shown in FIGS. 2A, 2B, 3 and 4. Opening 38 is aligned in wire mesh support 34 such that when catalytic converter 20 is completely assembled, opening 38 is aligned with cavity 36 to accomodate insertion of a probe, or sensor, 40, as shown in FIG. 4, into cavity 36. The sensor or probe enables parameters of interest of the exhaust gases passing through catalytic converter 20 to be be monitored within the cavity 36 of the catalytic converter. It will be recognized that measurement within the mid-bed cavity is a substantial improvement over the prior art which measured parameters in the exhaust flow by the use of one sensor upstream of catalytic converter 20 and a secondary sensor downstream of catalytic converter 20. The parameter of interest catalytic converter could then be approximated via the use of empirical formulae.

Opening 38, as shown in FIGS. 2A, 2B, 3, and 4, is formed by using a solid stamp to stamp a standardized opening in wire mesh support 34. If it is desired to cover the loose ends of the wire mesh, the mesh may be spot welded around the circumference. Alternatively, a grommet may be pressed into the opening to grip loose wire ends which may result from piercing the wire mesh. The grommet may optionally form an integral portion of the sensor.

In addition to metal wire, the mesh may also comprise silica fibers. Optionally, silica fiber may be interwoven within the wire mesh, or comprise one or more separate layers. Because silica has a lower coefficient of thermal conductivity than steel, (approximately two orders of magnitude) silica provides additional thermal insulation within the catalytic converter housing. Insulation protects vehicle components in close proximity to the catalytic converter, and prevents heat loss from the converter. It has been observed that when wire mesh support 34 is spot welded after opening 38 is stamped, silica fibers present may melt from the heat generated by welding then solidify around the wire mesh fibers to assist in securing the edges of opening 38.

By the addition of silica fibers to the wire mesh an external heat shield may be eliminated. The catalytic converter of the instant invention may require less space than the prior art catalytic converter combined with an external heat shield. Further, while the external heat shield provides protection for components in close proximity to the catalytic converter, the external heat shield does not contribute to temperature enhanced efficiency of the catalytic converter. In addition to allowing catalytic converter to use less package space in vehicle 10, the elimination of an external heat shield reduces vehicle weight the costs of manufacturing and assembling the external heat shield are eliminated.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A catalytic converter comprising:
a housing enclosing a plurality catalysts supports disposed in said housing, said catalyst supports defining a cavity between at least two of said substrates and the housing;
a resilient mesh extending between said supports and across said cavity.

2. The catalytic converter of claim 1 wherein said resilient mesh separator includes silica fiber.

3. The catalytic converter of claim 1 wherein said catalyst supports comprise a ceramic.

4. The catalytic converter of claim 1 wherein said housing and said mesh incorporate one or more co-located apertures.

5. The catalytic converter of claim 4 wherein the aperture(s) accommodate(s) an exhaust gas sensor.

6. The catalytic converter of claim 3 wherein said support catalyst has a honeycomb structure.

7. The catalytic converter of claim 6 wherein said aperture accommodates an exhaust gas sensor.

8. The catalytic converter of claim 2 wherein said mesh separator surrounds an outer circumferential surface a catalyst support compressing and maintain the position of the catalyst support within said housing.

9. A catalytic converter comprising:
a housing disposed in an engine exhaust stream;
a plurality of catalyst supports disposed within said housing, said catalyst supports defining a cavity between said catalyst supports said cavity being adapted to receive a sensor for monitoring properties of exhaust gas within said cavity; and
a wire mesh support extending between said catalyst supports and across said cavity, said wire mesh support incorporating at least one opening which receives a sensor into said cavity.

10. The catalytic converter of claim 11 wherein said cavity is insulated.

11. The catalytic converter of claim 11 wherein said support structure includes insulation whereby said supported catalysts and said cavity are insulated.

12. The catalytic converter of claim 13 wherein the wire mesh also comprises silica fibers.

13. The catalytic converter of claim 111 wherein a sensor is one selected from the group consisting of an oxygen sensor and a temperature sensor.

14. A method of making a catalytic converter capable of sensing conditions within the catalytic converter, the method comprising:
providing a housing and placing a plurality of catalyst supports within the housing such that at least one cavity is defined between the supported catalysts;
placing a wire mesh support within the housing such that the support covers at least a portion of the circumferential surface of the catalyst supports; and
inserting a sensor into the cavity through the housing and the wire mesh support.

15. The method of claim 16 wherein the wire mesh support comprises silica fibers.

16. A method of making a catalytic converter for use within an exhaust system associated with an internal combustion engine, the method comprising:
providing a housing sized to fit within the exhaust system;
inserting a plurality of catalyst supports within the housing circumferentially enclosed in a wire mesh support such that at least one cavity is defined within the housing and between catalyst supports;
piercing the housing and wire mesh support to form an opening in the cavity for receipt of a sensor; and
inserting a sensor through the opening of the separator and into the cavity.

17. An internal combustion engine exhaust system comprising the catalytic converter according to claim 1.

18. A motor vehicle comprising an internal combustion engine according to claim 20
